(19) United States
(12) Patent Application Publication
(10) Pub. No.: US 2015/0116523 A1
(43) Pub. Date: Apr. 30, 2015

(54) IMAGE SIGNAL PROCESSOR AND METHOD FOR GENERATING IMAGE STATISTICS

(71) Applicant: Nvidia Corporation, Santa Clara, CA (US)

(72) Inventors: Abhinav Sinha, Santa Clara, CA (US); Yining Deng, Santa Clara, CA (US); Patrick Shehane, Santa Clara, CA (US)

(73) Assignee: Nvidia Corporation, Santa Clara, CA (US)

(21) Appl. No.: 14/063,619

(22) Filed: Oct. 25, 2013

(51) Int. Cl. H04N 5/232

(52) U.S. Cl. CPC H04N 5/23206
USPC 348/211.3

(57) ABSTRACT

An image signal processor (ISP) and a method of generating image statistics. One embodiment of the ISP includes: (1) a client configured to employ image statistics to process a current frame of a scene if changes in the current frame relative to a previous frame of the scene rise above a threshold, and (2) a statistics engine associated with the client and configured to generate the image statistics based on the current frame if the changes rise above the threshold.

### TECHNICAL FIELD

This application is directed, in general, to generating image statistics for image processing and, more specifically, to reducing the amount of computation involved in computing image statistics.

### BACKGROUND

Digital cameras have become increasingly more sophisticated, incorporating cutting edge image processing techniques and advanced features. Yet, digital cameras are also increasingly more compact and mobile. A critical aspect of mobile digital cameras is power consumption, an aspect that is further stressed by latest technologies. A majority of new digital cameras are contained in cellular phones, smart phones, and tablet computers, where power constraints are great. The newest mobile devices boast larger displays, better displays, faster processors, extra gadgets, better software, and better cameras. All of these features and technology enhancements spell increased power demand.

The countervailing trend in mobile devices is smaller, lighter batteries. Developments in battery technology have delivered, yielding smaller batteries that weigh less, are more efficient, charge quickly, hold charge longer, and are sometimes even environmentally friendly. The stark reality is that battery technology often lags power demands, making power consumption an important focus area in mobile technology, particularly staying within power constraints.

### SUMMARY

One aspect provides an image signal processor (ISP). In one embodiment, the ISP includes: (1) a client configured to employ image statistics to process a current frame of a scene if changes in the current frame relative to a previous frame of the scene rise above a threshold, and (2) a statistics engine associated with the client and configured to generate the image statistics based on the current frame if the changes rise above the threshold.

Another aspect provides a method of generating image statistics. In one embodiment, the method includes: (1) registering a statistics client with a statistics engine, (2) quantifying change between a current frame and a previous frame of a scene, and (3) employing the statistics engine in generating image statistics if the change rises above a threshold registered by the statistics client.

Yet another aspect provides a digital camera. In one embodiment, the camera includes: (1) a camera sensor operable to capture a current frame and a previous frame of a scene, (2) a change detection module configured to quantify a change between the current frame and the previous frame, (3) a statistics engine configured to generate image statistics based on the current frame at a frequency if the change rises above a threshold, and (4) a client configured to specify the threshold and the frequency, and operable to employ the image statistics to process the current frame.

Yet another aspect provides an ISP, including: (1) a client configured to employ image statistics to process every Nth frame of a scene, wherein N is a frequency period, and (2) a statistics engine associated with the client and configured to generate the image statistics for the every Nth frame.

### BRIEF DESCRIPTION

Reference is now made to the following descriptions taken in conjunction with the accompanying drawings, in which:

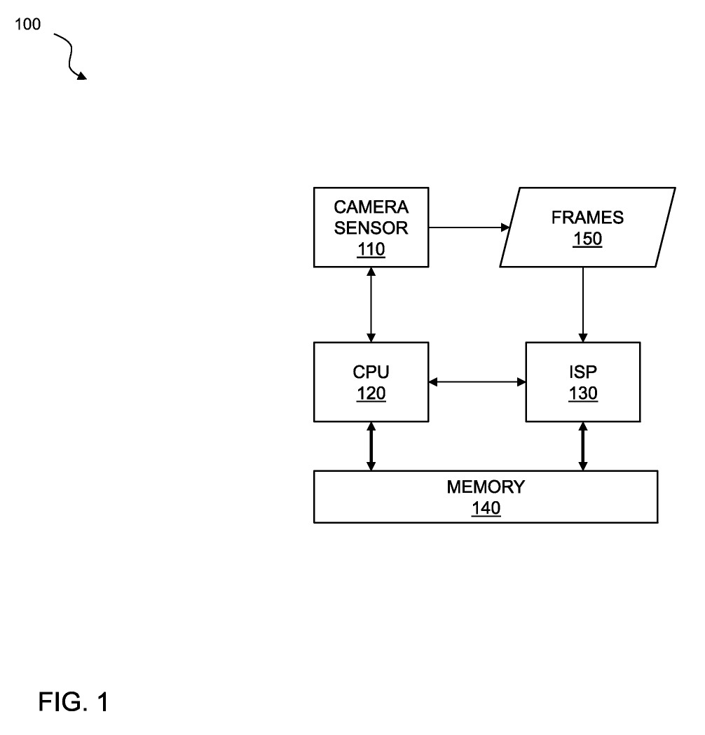

FIG. 1 is a block diagram of one embodiment of a digital camera;

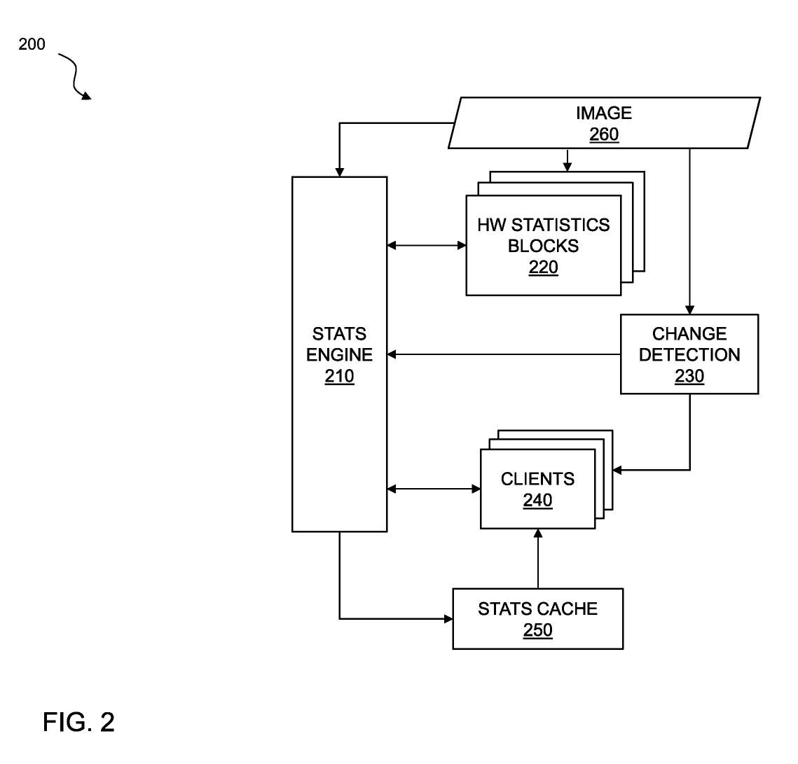

FIG. 2 is a block diagram of one embodiment of an ISP; and

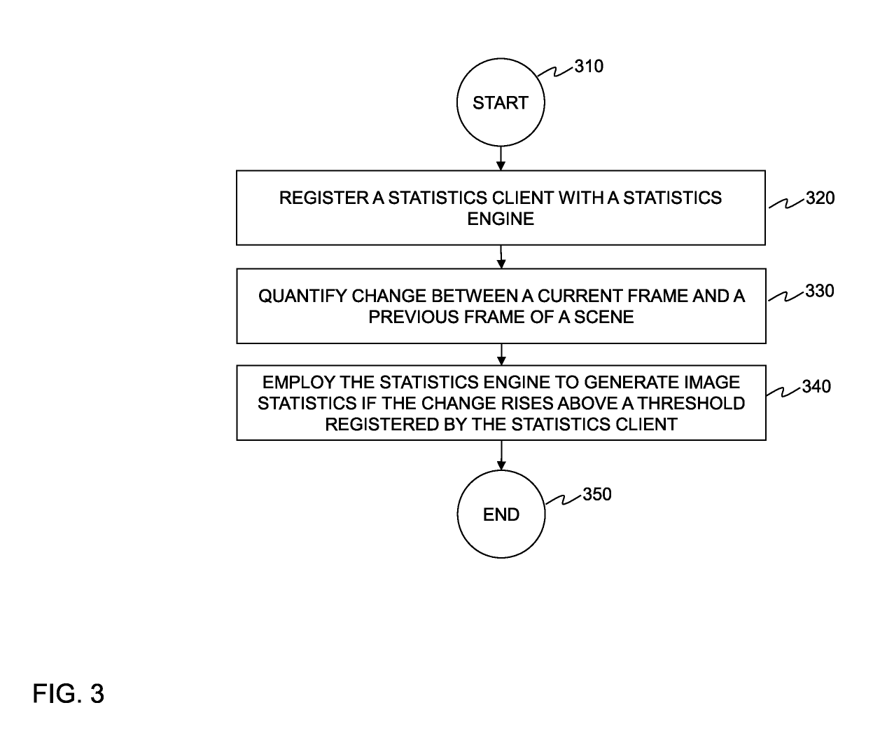

FIG. 3 is a flow diagram of one embodiment of a method of generating image statistics.

### DETAILED DESCRIPTION

A digital camera operates by capturing a scene as an image or a frame of video, and processing that scene to produce a digitally formatted image or video. Digital cameras typically have various modules that operate on statistical information in the scene. For example, an auto exposure (AE) module uses the intensity information in the image to adjust the camera exposure. Other modules, or “clients,” that use statistical information include auto white balance (AWB), auto focus (AF), tone curve, flicker control, and others. The statistical information is generated by an ISP within the digital camera. Image statistics can be generated by ISP hardware, ISP software, or a combination of ISP hardware and software. ISP hardware includes statistics blocks that extract statistical information while processing image data. For example, window-based sample averages and image histogram are two common statistics blocks implemented in ISP hardware. Otherwise, image statistics are generated by an ISP software statistics engine.

It is realized herein that computation cycles and power can be conserved by only computing image statistics when the changes in a scene rise above a certain threshold. The threshold can be specified by each client for each image statistic requested by that client. Additionally, it is realized herein that, the client itself can conserve power and computation cycles by using a quantification of change between a current frame and a previous frame to determine whether to process the current frame. It is further realized herein that computation cycles and power can be further conserved by computing image statistics according to the frequency a particular client operates. Certain clients need only operate a fraction of the total frames captured by the camera or, in other words, every Nth frame, where N is the frequency period. For example, some processes may run every third frame, while others may run every fifth. The value of the frequency period, or “N,” can range from one (every frame) to the total number of frames (one frame). The value used by a particular client depends on the function the particular client serves. It is realized herein that the statistics engine, given knowledge of that frequency, can schedule the computation of certain image statistics so that unnecessary computations are avoided. It is also realized herein that the statistics engine can combine the frequency and threshold information to determine when image statistics should be computed, including activating and deactivating ISP hardware statistics blocks and executing ISP software modules that contribute to the computation of image statistics.

It is realized herein the change threshold and the frequency can be employed independently or together. Employing the change threshold compliments the savings achieved by employing the frequency. An embodiment employing the frequency can reduce power and computation cycle consumption by only computing image statistics as they are needed by one or more statistics clients. Additionally employing the change threshold can yield further savings. Likewise, the change threshold can be employed without the frequency, yielding power and processing savings, or in combination with the frequency, possibly yielding further savings.

FIG. 1 is a block diagram of one embodiment of a digital camera 100 within which the ISP or method of generating image statistics introduced herein may be embodied or carried out. Digital camera 100 includes a camera sensor 110, a central processing unit (CPU) 120, an ISP 130, and memory 140. Digital camera 100 is distinct from a digital camera device in that digital camera 100 can be embodied in a device other than one solely dedicated to digital photography or video capture, such as a digital camera device. Digital camera 100 can be embodied in a digital camera device, such as a “point-and-shoot” camera or a digital single-lens reflex (DSLR) camera. Similarly, digital camera 100 can be embodied in a digital video camera device. Digital camera 100 can also be embodied within a mobile computing device, such as a cellular phone, smart phone, tablet computer, laptop computer, portable game system, and many other devices.

CPU 120 is a processor that is communicably coupled to camera sensor 110 and memory 140. CPU 120 executes a program stored in memory 140, thereby generating commands for camera sensor 110 to carry out. Communicably coupled is herein defined as being arranged such that electrical signals can pass from one component to another. For example, camera sensor 110 and CPU 120 can be communicably coupled by a data bus. Alternatively, camera sensor 110 and CPU 120 can be communicably coupled by a conductive wire attached between a terminal of CPU 120 and a terminal of camera sensor 110. Similarly, communicably coupling CPU 120 and memory 140 can be achieved by a data bus or other conductive means.

When commanded, camera sensor 110 observes a scene by sensing reflected light. Camera sensor 110 collects the reflected light and forms frames 150 of the scene. Frames 150 are stored in memory 140. In certain embodiments camera sensor 110 is a still-frame sensor capable of capturing standard still digital images, while in other embodiments, camera sensor is a video sensor, capable of capturing a series of frames to form a digital video.

CPU 120 is also communicably coupled to ISP 130. CPU 120 generates commands for ISP 130 to retrieve frames 150 from memory 140 and carry out image processing to generate a digitally formatted image. Certain image processing requires statistical information, or image statistics, based on frames 150. Processing is carried out by a variety of modules, or statistics clients, in ISP 130 dedicated to a particular process or effect. The statistics are generated by ISP hardware, ISP software, or a combination of the two. The resulting image can then be stored in memory 140 or, in certain embodiments, displayed. For example, in embodiments of digital camera 100 having a “view finder” display, frames 150 are captured, processed, and displayed on the view finder display in real-time. Processing frames 150 allows application of certain effects, including AE, AWB, AF, tone curve, flicker control, and others.

FIG. 2 is a block diagram of one embodiment of an ISP 200. ISP 200 includes a statistics engine 210, hardware statistics blocks 220, a change detection module 230, clients 240, and a statistics cache 250. ISP 200 is operable to generate image statistics for an image 260. The generated image statistics are then used by clients 240 to process image 260, yielding certain effects in the resulting digital image.

Hardware statistics blocks 220 are dedicated modules configured to extract information from image 260 to generate basic image statistics. In certain embodiments, hardware statistics blocks 220 are configured to compute window-based sample averages, or “window statistics.” Window statistics contain small thumbnails of a region of interest in a frame of image 260. Other embodiments include modules configured to generate image histograms. Basic image statistics are sometimes used to compute “derived statistics” for image 260.

Statistics engine 210 is typically a software module within ISP 200 operable to receive image data, optionally process it, thereby generating image statistics that can be passed along to other modules, including clients 240. In alternate embodiments, statistics engine 210 also incorporates certain hardware elements to carry out at least a portion of the necessary statistics computations. Image statistics generated by hardware statistics blocks 220 are sometimes not readily useable by clients 240 and require further derivations. Statistics engine 210 computes those derivations, thereby generating further images statistics, or derived statistics. Image statistics generated by statistics engine 210 are made available to clients 240 via statistics cache 250. Statistics cache 250 is a memory space allocated to store recent image statistics and is quickly accessible by various other modules, relative to storing image statistics in other, larger memory blocks. Statistics cache 250 also reduces redundant image statistic computations when two clients request the same image statistic.

Change detection module 230 includes ISP hardware, ISP software, or a combination of ISP hardware and software. Change detection module 230 is operable to carry out at least basic scene change detection and quantify the change from frame to frame. Change detection, in certain embodiments, uses basic image statistics generated by hardware statistics blocks 220. For example, a comparison between window statistics of a current frame of a scene and a previous frame of the scene can illustrate differences between the two frames. In other embodiments, other change detection methods and comparison metrics can be employed, including the sum of absolute differences of all values and its ratio to the mean, maximum difference of all values, standard deviation, and others.

The quantified change generated by changed detection module 230 can then be used by statistics engine 210 and clients 240 to make decisions in respective processes. Clients 240 are modules dedicated to applying a certain effect on image 260. Clients 240 employ image statistics to achieve that effect, and rely on statistics engine 210 to provide those image statistics. It is unnecessary for certain clients, of clients 240, to operate on every frame of image 260. Certain clients may only need to execute periodically, for example, every third frame. Other clients may indeed need to execute on every frame. Each of clients 240 specifies the frequency at which it operates. Similarly, each of clients 240 is configured to specify a threshold of change between frames, below which, processing is unnecessary. For example, many processes implemented by clients 240 could be unnecessary if at least 90% of image 260 is unchanged from the previous frame to the current frame. This threshold is typically unique to each of clients 240. Some embodiments of clients 240 may require less than 1% change between frames to initiate processing. Other embodiments of clients 240 may require at least a 50% change, at least a 70% change, or more. If the quantified change computed by change detection module 230 does not rise above the threshold for a particular client, that client does not seek image statistics or compute its respective effect for the current frame. If the quantified change does rise above the threshold, then that client carries out its processing as usual.

Clients 240 are also operable to communicate respective image statistics demands to statistics engine 210. In certain embodiments, clients 240 carry out a registration process with statistics engine 210. The registration process allows clients 240 to communicate respective change thresholds and frequencies to statistics engine 210. Additionally, clients 240 are configured to communicate their respective requested image statistics to statistics engine 210. Given knowledge of a particular client's frequency of computation, statistics engine 210 can schedule computation of requested image statistics according to that schedule. For example, if a particular client specifies a frequency of every third frame, statistics engine 210 would schedule the requested image statistics for computation every third frame. Otherwise, processing cycles and therefore power, are conserved when new image statistics are unnecessary. Similarly, given knowledge of a particular client's change threshold, statistics engine 210 can use the quantified change generated by change detection module 230 to make a real-time determination as to whether the requested image statistics should be computed. If the quantified change does not rise above the threshold, the requested image statistics are not computed. Otherwise, when the quantified change does rise above the threshold, the requested image statistics are computed according to the frequency registered with statistics engine 210 by the particular client.

In certain embodiments, statistics engine 210 is additionally configured to control operation of at least some of hardware statistics blocks 220. For example, if statistics engine 210 is configured to employ hardware statistics blocks 220 to compute a requested image statistic, hardware statistics blocks 220 can be deactivated when new image statistics are unnecessary. If a client's registered frequency causes an image statistic to be schedule for a fraction of the frames, hardware statistics blocks 220 are only active when computation of a particular image statistic is due. Similarly, if the quantified change generated by change detection module 230 does not rise above the threshold registered by a particular client, and that client's request image statistics rely on basic image statistics generated by hardware statistics blocks 220, hardware statistics blocks 220 can be deactivated for the current frame. This allows ISP 200 to conserve power otherwise consumed by hardware statistics blocks 220 in computing unnecessary image statistics, in addition to power and computing cycles conserved in statistics engine 210 and clients 240.

FIG. 3 is a flow diagram of one embodiment of a method of generating image statistics. The method begins in a start step 300. In a registration step 320, a statistics client registers with a statistics engine. During registration, the statistics client communicates various pieces of data to the statistics engine, including a change threshold, a request for image statistics, and, in certain embodiments, a computation frequency. The computation frequency is the frequency at which the statistics client desires image statistics. The statistics client is configured to process a frame of a scene at a computational frequency if the frame contains changes relative to a previous frame that rise above the change threshold. Processing the frame includes using the requested image statistics to compute a certain effect for the resulting image. The statistics client is configured to generate the requested statistics.

In a change detection step 330, the change between a current frame and the previous frame of the scene is quantified. Change detection step 330 can be carried out by any change detection technique, and can be embodied in hardware or software, within the ISP or independent of the ISP. Quantification of change between the current and previous frames can be expressed in terms of fraction of pixels changed, fraction of blocks of pixels changed, or any other reasonable quantification.

The statistics engine is employed to generate the image statistics in a computation step 340. The statistics engine is configured to generate the image statistics if the quantified change from change detection step 330 rises above the threshold registered with the statistics engine by the client in registration step 320. By not unnecessarily computing new image statistics when the scene has not changed from one frame to the next, computation cycles and power are conserved.

Alternate embodiments can include a further restriction on computation step 340 by only generating image statistics if the image statistics are due according to the frequency registered by the statistics client in registration step 320. Independent of, but complimentary to the change threshold, image statistics are only computed by the statistics engine for the frames that will be processed by the statistics client. For example, if the statistics client registers a frequency of every fifth frame in registration step 320, the statistics engine will not generate new image statistics for four of five frames. Computation cycles and power are thereby conserved. The method then ends in an end step 350.

Those skilled in the art to which this application relates will appreciate that other and further additions, deletions, substitutions and modifications may be made to the described embodiments.

What is claimed is:

1. An image signal processor (ISP), comprising:
a client configured to employ image statistics to process a current frame of a scene if changes in said current frame relative to a previous frame of said scene rise above a threshold; and
a statistics engine associated with said client and configured to generate said image statistics based on said current frame if said changes rise above said threshold.

2. The ISP as recited in claim 1 further comprising a change detection module associated with said statistics engine and operable to generate a quantification of said change and provide said quantification to said client and said statistics engine.

3. The ISP as recited in claim 1 wherein said client is further configured to specify said threshold and operable to communicate said threshold to said statistics engine.

4. The ISP as recited in claim 1 wherein said client is further configured to specify a frequency at which said image statistics are to be generated and employed, and operable to communicate said frequency to said statistics engine.

5. The ISP as recited in claim 4 wherein said statistics engine is configured to employ said frequency to initiate generation of said image statistics.

6. The ISP as recited in claim 5 further comprising a hardware statistics module associated with said statistics engine and operable to process said current frame to generate basic statistics employable by said statistics engine to generate said image statistics.

7. The ISP as recited in claim 6 wherein said statistics engine is further configured to disable said hardware statistics module based on said frequency.

8. A method of generating image statistics, comprising:
registering a statistics client with a statistics engine;
quantifying change between a current frame and a previous frame of a scene; and
employing said statistics engine in generating image statistics if said change rises above a threshold registered by said statistics client.

9. The method as recited in claim 8 wherein said registering includes identifying said threshold and a frequency at which said image statistics should be generated.

10. The method as recited in claim 9 wherein said generating is only carried out if said image statistics are due according to said frequency.

11. The method as recited in claim 8 further comprising writing said image statistics to a statistics cache.

12. The method as recited in claim 8 wherein said employing includes utilizing hardware statistics modules.

13. The method as recited in claim 8 wherein said generating includes extracting basic statistics from said current frame.

14. The method as recited in claim 13 wherein said generating includes computing derived statistics from said basic statistics.

15. A digital camera, comprising:
a camera sensor operable to capture a current frame and a previous frame of a scene;
a change detection module configured to quantify a change between said current frame and said previous frame;
a statistics engine configured to generate image statistics based on said current frame at a frequency if said change rises above a threshold; and
a client configured to specify said threshold and said frequency, and operable to employ said image statistics to process said current frame.

16. The digital camera as recited in claim 15 further comprising a statistics cache configured to store said image statistics written thereto by said statistics engine.

17. The digital camera as recited in claim 15 further comprising image signal processor (ISP) hardware statistics modules communicably coupled to said statistics engine and configured to process said current frame, thereby yielding basic statistics.

18. The digital camera as recited in claim 17 wherein said statistics engine is operable to generate derived statistics based on said basic statistics.

19. The digital camera as recited in claim 17 wherein said statistics engine is further configured to disable said ISP hardware statistics modules according to said frequency.

20. The digital camera as recited in claim 15 wherein said frequency specifies said image statistics be computed every third frame.

21. An image signal processor (ISP), comprising:
a client configured to employ image statistics to process every Nth frame of a scene, wherein N is a frequency period; and
a statistics engine associated with said client and configured to generate said image statistics for said every Nth frame.

22. The ISP as recited in claim 21 wherein N is three.

23. The ISP as recited in claim 21 wherein said client is operable to specify and communicate said frequency period to said statistics engine.

24. The ISP as recited in claim 21 further comprising a hardware statistics module operable to receive instructions from said statistics engine and periodically generate at least a portion of said image statistics based on said instructions.

25. The ISP as recited in claim 21 wherein said statistics engine is operable to employ said frequency period to control power to said hardware statistics module.
